(19) United States
(12) Patent Application Publication
(10) Pub. No.: US 2013/0025452 A1
(43) Pub. Date: Jan. 31, 2013

(54) METHOD AND DEVICE FOR SCRUBBING MEDIUM REGENERATION IN GAS SCRUBBERS

(71) Applicants: Horst WEISS, Munchen (DE); Ulvi Kerestecioglu, Geltendorf (DE)

(72) Inventors: Horst WEISS, Munchen (DE); Ulvi Kerestecioglu, Geltendorf (DE)

(73) Assignee: LINDE AKTIENGESELLSCHAFT, Munchen (DE)

(21) Appl. No.: 13/558,787

(22) Filed: Jul. 26, 2012

(30) Foreign Application Priority Data
Jul. 26, 2011 (DE) 10 2011 108 530.4

(51) Int. Cl. B01D 19/00

(52) U.S. Cl. 95/266; 96/193; 96/201

(57) ABSTRACT

The invention relates to a method and apparatus for regenerating a scrubbing medium used at elevated pressure in a physical gas scrubber for purifying a feed gas containing hydrogen and carbon monoxide. The scrubbing medium, loaded with carbon dioxide and sulphur components, is expanded to a pressure between 0.4 and 1.7 bar(a), liberating a carbon dioxide-rich, sulphur component-containing gas. This gas is compressed and introduced into a scrubbing column, in which sulphur components are scrubbed out of the carbon dioxide-rich gas using sulphur-free scrubbing medium.

### SUMMARY OF THE INVENTION

The invention relates to a method for regenerating a scrubbing medium that is used at elevated pressure in a physical gas scrubber for purifying a feed gas containing hydrogen and carbon monoxide and in the process is loaded with carbon dioxide and sulphur components. The invention further relates to an apparatus for carrying out the method.

Physical gas scrubbers utilize the property of liquids of absorbing and retaining in solution gaseous substances without binding the gases chemically in the process. How well a gas is absorbed by a liquid is expressed by the solubility coefficient: the better the gas dissolves in the liquid, the greater its solubility coefficient. The solubility coefficient generally rises with falling temperature.

The gas components that are scrubbed out are, subsequently to the gas scrubber, removed from the loaded scrubbing medium, thereby regenerating the scrubbing medium. The regenerated scrubbing medium is usually used again in the gas scrubber, while the gas components that are scrubbed out are either disposed of or fed to an economic use.

In order to obtain hydrogen and carbon monoxide on an industrial scale, in the prior art, carbon-containing feedstocks are converted into a crude synthesis gas by gasification. Such a crude synthesis gas, in addition to the desired constituents hydrogen and carbon monoxide, also contains a number of unwanted constituents such as carbon dioxide (CO₂), hydrogen sulphide (H₂S) and carbonyl sulphide (COS). For separation of the unwanted constituents from the desired constituents, the crude synthesis gas is preferably subjected to a physical gas scrubber. Such a method is suggested for this purpose, since the crude synthesis gas is now usually generated at high pressure and the effectiveness of a physical gas scrubber, to a first approximation, increases linearly with the operating pressure.

The methanol scrubber is of particular importance for purifying crude synthesis gases. It exploits the fact that the solubility coefficients of the unwanted constituents in low-temperature methanol are greater by several orders of magnitude than those of H₂ and CO. Since the solubility coefficients of carbon dioxide and the sulphur components H₂S and COS increase greatly with decreasing temperature, the methanol scrubbing medium is usually introduced into an absorber column at a temperature which is far below 0° C. and brought into intensive contact with the synthesis gas that is to be purified. The methanol that is loaded with unwanted constituents is regenerated after the scrubbing operation and returned to the scrubbing process.

For the regeneration, the loaded methanol scrubbing medium, according to the prior art, is withdrawn from the absorber column and introduced into the upper region of what is termed an enrichment column, which is a stripping column. In the enrichment column, a stripping gas, which is usually nitrogen, is conducted in counterflow and removes predominantly CO₂ from the methanol scrubbing medium, as a result of which the sulphur components are enriched. The cold generated during the CO₂ expulsion is utilized for decreasing the unavoidable losses in cold of the methanol scrubber.

The gas mixture, which predominantly consists of CO₂ and stripping gas, is withdrawn from the top of the enrichment column. This gas mixture generally can not be utilized economically, for which reason it is subsequently disposed of. One type of disposal is to release of the gas mixture into the atmosphere, which, however, with respect to the warming of the Earth's atmosphere, is increasingly considered to be a problem. Other conceivable disposal methods are introducing the gas mixture into deep strata (sequestration) or using the gas mixture in the exploitation of oil wells (Enhanced Oil Recovery). For this purpose, however, the nitrogen content thereof is restricted to low values of less than approximately 4 mol %. This prevents the use of nitrogen as a stripping gas, as is currently usual.

It is therefore an aspect of the present invention to provide a method of the type in question and also a device for carrying out this method in such a manner that the disadvantages of the prior art are overcome.

Upon further study of the specification and appended claims, other aspects and advantages of the invention will become apparent.

These aspects are achieved by expanding the scrubbing medium, loaded with carbon dioxide and sulphur components, to a pressure between 0.4 and 1.7 bar(a), preferably between 1.0 and 1.3 bar(a). The carbon dioxide-rich, sulphur component-containing gas that is liberated during the expansion is compressed and introduced into a scrubbing column. In this scrubbing column, sulphur components are scrubbed out of the carbon dioxide-rich gas using a sulphur-free scrubbing medium.

A sulphur-free scrubbing medium in this context is taken to mean a scrubbing medium in which the content of sulphur components is less than 10 ppm, preferably less than 5 ppm, especially 1-2 ppm. The scrubbing medium preferably has a greater absorption coefficient for the sulphur components over carbon dioxide such as in the case of a scrubbing medium that is already loaded with carbon dioxide. The scrubbing medium can be, for example, methanol, N-methylpyrrolidone, or polyethyleneglycol dimethyl ether.

The carbon dioxide-rich gas is for logical reasons introduced into the lower section of the scrubbing column and there conducted upwardly in counterflow to the sulphur-free scrubbing medium. The sulphur-free scrubbing medium is preferably a scrubbing medium saturated with carbon dioxide, for example, scrubbing medium that was loaded with carbon dioxide during the purification of the feed gas which is already largely freed from sulphur components. Sulphur components present in the carbon dioxide-rich gas are absorbed by the sulphur-free scrubbing medium, whereas carbon dioxide largely remains in the gas phase.

The concentration of the carbon dioxide that remains in the loaded scrubbing medium, i.e., the scrubbing medium loaded during the purification of the hydrogen/carbon monoxide-containing feed gas, is substantially determined via the pressure to which the loaded scrubbing medium is expanded. By expanding to pressures close to or below the ambient pressure (e.g., 0.4-1.7 bar), the carbon dioxide content of the loaded scrubbing medium can be reduced to very low values. At the same time, the carbon dioxide separated off in the scrubbing column can be obtained in any desired purity and delivered as product and used, for example, for Enhanced Oil Recovery.

In order to increase the efficiency of the method, it can be useful to expand the loaded scrubbing medium in at least two steps, in such a manner that carbon dioxide-rich gas is generated at at least two different pressure levels, and only some of the carbon dioxide separated off from the loaded scrubbing medium is present at the lowest pressure level. For example, expansion of the loaded scrubbing medium in at least two steps can produce one carbon dioxide-rich gas stream at 1.0-1.7 bar and another carbon dioxide-rich gas stream at 0.4-1.0 bar. In order to compress the total amount of the carbon dioxide separated off to a uniform pressure needed for introduction into the scrubbing column, a lower energy consumption is therefore required than in the case of single-stage expansion of scrubbing medium.

In order that the heat introduced during the compression of the carbon dioxide-rich gas need only be compensated for to a small part in the process by means of expensive external refrigeration at a low temperature level, it is proposed to cool the carbon dioxide-rich gas after compression thereof and before introduction thereof into the scrubbing column. For this cooling, cooling water or external refrigeration at a comparatively high temperature level can be used.

In principle, the method according to the invention can be used for regenerating any desired scrubbing medium. However, the method is particularly advantageous in regenerating loaded methanol or N-methylpyrrolidone (NMP) or polyethyleneglycol dimethyl ether (PEGE).

In addition, the invention relates to an apparatus for regenerating a scrubbing medium that is used at elevated pressure in a physical gas scrubber for purifying a feed gas containing hydrogen and carbon monoxide and in the process is loaded with carbon dioxide and sulphur components.

The apparatus according to the invention comprises an expansion vessel and a scrubbing column, both of which are connected via a compressor. In the regeneration process, a loaded scrubbing medium can be expanded via a throttle element (e.g., a valve) into the expansion vessel, and gas liberated during the expansion can be compressed using the compressor and introduced into the scrubbing column.

An expedient configuration of the invention comprises at least two serially-arranged expansion vessels, wherein in each case two adjacent expansion vessels are connected to one another via a throttle element, in such a manner that loaded scrubbing medium can be conducted through the expansion vessels and in the process expanded to different pressure levels. Preferably, for compression of the gas streams obtainable in the expansion vessels, a compressor having a plurality of compressor sections is used, the number of which is greater than or equal to the number of the expansion vessels. For logical reasons, the entry side of a compressor section is connected at most to one expansion vessel in such a manner that gas can be fed from the expansion vessel to the compressor section. By this configuration it is possible to carry out the compression of the gas liberated during the expansion with a lower energy consumption than is possible using a single-stage expansion.

If the pressure difference between a first tank from which loaded scrubbing medium can be withdrawn and a second tank into which the scrubbing medium that is withdrawn can be expanded via a throttle element is not sufficient to ensure stable control of the system operation via the throttle element, the invention provides a pump arranged upstream of the throttle element, via which pump the pressure of the loaded scrubbing medium prevailing upstream of the throttle element can be elevated. Alternatively, or in addition thereto, the first tank can also be arranged to be shifted above the second tank and the throttle element, in such a manner that the hydrostatic pressure of the scrubbing medium can be increased upstream of the throttle element.

In order to minimize the use of expensive external refrigeration at a low temperature level, or to increase some of the external refrigeration required in the process to a higher temperature level that may be generated more cheaply, one configuration of the invention provides a heat exchanger arranged between compressor and scrubbing column, via which heat exchanger compressed gas can be cooled, for example using cooling water, before introduction thereof into the scrubbing column.

The scrubbing column and the expansion vessel or vessels may be embodied as separate components or as a structural unit.

### BRIEF DESCRIPTION OF THE DRAWINGS

Various other features and attendant advantages of the present invention will be more fully appreciated as the same becomes better understood when considered in conjunction with the accompanying drawings wherein:

FIG. 1 illustrates an embodiment according to the invention;

FIG. 2 illustrates a further embodiment of the invention comprising two serially-arranged expansion vessels;

FIG. 3 illustrates an embodiment wherein a pump is arranged upstream of a throttle element to elevate the pressure of loaded scrubbing medium upstream of the throttle element; and

FIG. 4 illustrates an embodiment wherein a heat exchanger is arranged between a compressor and the scrubbing column to cool compressed gas before introduction thereof into the scrubbing column.

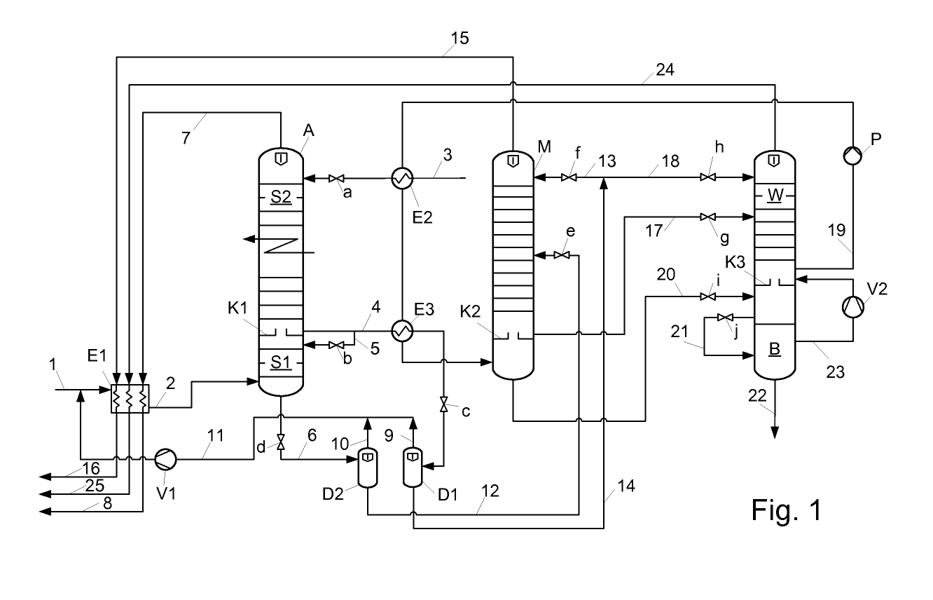

FIG. 1 shows a section of a physical gas scrubber in which carbon dioxide and sulphur components are scrubbed out of a crude synthesis gas using liquid and low-temperature methanol.

The crude synthesis gas to be scrubbed which, in addition to hydrogen and carbon monoxide, also contains carbon dioxide and sulphur components, is introduced via conduit 1 into the heat exchanger E1 and cooled there against process streams that are to be warmed, before being delivered via conduit 2 to the lower region of an absorber column A. The absorber column A, which is typically operated at a pressure between 15 and 80 bar, has a lower scrubbing section S1 and an upper scrubbing section S2 which are separated from one another by a chimney tray K1. The cold crude synthesis gas is passed upward in the absorber column A and is brought in the course of this into intensive contact with methanol scrubbing medium which is introduced, unloaded, via conduit 3 into the scrubbing section S2. The flow rate of the methanol scrubbing medium is adjusted via the control element a (e.g., a valve), in such a manner that carbon dioxide is scrubbed out of the crude synthesis gas predominantly completely or down to a desired degree. Via conduits 4 and 5, and also control element b (e.g., a valve), at least a portion of methanol scrubbing medium, already pre-loaded with carbon dioxide, is passed further into the scrubbing section S1, where, owing to its flow rate, predominantly sulphur components are absorbed from the crude synthesis gas before it is withdrawn from the bottom chamber of column A loaded with carbon dioxide and sulphur components and passed further via conduit 6. From the top of the absorber column, a gas 7 predominantly comprising hydrogen and carbon monoxide can be withdrawn, which gas, after warming against the crude synthesis gas 1, is delivered as synthesis gas product 8.

The loaded methanol streams 4 and 6 are expanded via the throttle elements c and d (e.g., valves) into the separator D1 or D2, respectively. The gas phases formed in this case which predominantly comprise hydrogen and carbon monoxide co-absorbed in the gas scrubber are returned to the crude synthesis gas 1 via the conduits 9 or 10 and 11 and also the compressor V1.

In order to convert dissolved carbon dioxide to the gas phase, the loaded methanol 12 is withdrawn from the separator D2 and expanded via the throttle element e into the middle part of the medium-pressure column M that is typically operated between 3 and 4.5 bar. Sulphur components that are likewise liberated during the expansion are rescrubbed using a part 13 of the sulphur-free methanol stream 14 that is predominantly loaded with carbon dioxide, which for this purpose is expanded via the throttle element f into the top of the medium-pressure column M. From the medium-pressure column M, a substantially sulphur-free carbon dioxide stream 15 can, therefore, be withdrawn which, after warming against the crude synthesis gas 1 is delivered as a first carbon dioxide product 16.

In the chimney tray K2 of the medium-pressure column M, carbon dioxide-containing methanol that is predominantly loaded with sulphur components is collected, withdrawn via conduit 17, and expanded via the throttle element g into the middle part of the scrubbing column W. For rescrubbing of sulphur components, at the top of the scrubbing column W, the second part 18 of the sulphur-free methanol stream 14 that is predominantly loaded with carbon dioxide is introduced via the throttle element h. Using the pump P, methanol that is rich in sulphur components but still contains carbon dioxide is withdrawn from the chimney tray K3 of the scrubbing column W via conduit 19 and introduced into the bottom chamber of the medium-pressure column M, after being warmed in the heat exchangers E2 and E3 against regenerated methanol 3 and loaded methanol 4, respectively. The warming expels some of the carbon dioxide present in the methanol. The expelled carbon dioxide is delivered at a higher pressure overhead from the medium-pressure column M with the stream 15. The scrubbing medium still loaded with sulphur and residues of carbon dioxide is withdrawn from the bottom chamber of the medium-pressure column M via conduit 20 and expanded via the throttle element i into the lower part of the scrubbing column W, wherein a further part of the dissolved carbon dioxide is liberated.

Then, the sulphur-rich methanol 21 is withdrawn from the scrubbing column W and conducted via the throttle element j into the expansion vessel B. The expansion vessel B, together with the scrubbing column W, forms a structural unit. Owing to the pressure prevailing here, which can be below atmospheric pressure, a carbon dioxide-rich gas phase containing sulphur components is formed, and also a methanol enriched with sulphur components which is greatly reduced in carbon dioxide. Whereas the sulphur-rich methanol is fed via conduit 22 to a hot regeneration (which is not shown), the carbon dioxide-rich gas phase is withdrawn from the expansion vessel B via conduit 23 and the compressor V2 and returned to the scrubbing column W for rescrubbing of the sulphur components.

A carbon dioxide stream 24 is withdrawn from the top of the scrubbing column W and, after warming against the crude synthesis gas 1, is delivered, on account of its purity, as second carbon dioxide product 25. The carbon dioxide products 16 and 25 are fed to a compressor unit (which is not shown) and can be utilized, for example, for Enhanced Oil Recovery.

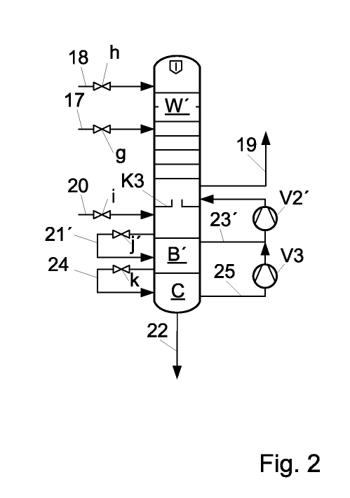

In FIG. 2 scrubbing column W′ for rescrubbing of sulphur is associated with two serially-arranged expansion vessels, i.e., expansion vessel B′ and expansion vessel C. Sulphur-rich methanol 21′ is withdrawn from the scrubbing column W′ and conducted via the throttle element j into the expansion vessel B′. A carbon dioxide-rich gas phase is withdrawn from the expansion vessel B′ via conduit 23′ and the compressor V2′ and returned to the scrubbing column W′ for rescrubbing of the sulphur components.

Methanol scrubbing medium 24 is withdrawn from the expansion vessel B′ and conducted via the throttle element k into the expansion vessel C. A carbon dioxide-rich gas phase is withdrawn from the expansion vessel C via conduit 25 and the compressors V3 and V2′ and returned to the scrubbing column W′ for further rescrubbing of the sulphur components.

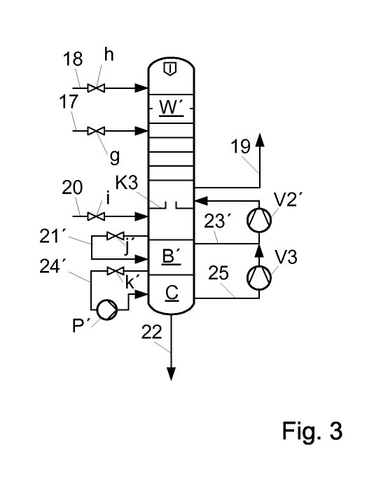

In the embodiment of FIG. 3, like in FIG. 2, scrubbing column W′ is associated with two serially-arranged expansion vessels, i.e., expansion vessel B′ and expansion vessel C. In this embodiment, methanol scrubbing medium 24′ is withdrawn from expansion vessel B′ and conducted via the throttle element k′ into the expansion vessel C. In order to ensure that the pressure difference between expansion vessel B′ and expansion vessel C is sufficient to ensure stable control of the system operation via the throttle element k′, a pump P′ is arranged upstream of the throttle element k′. Pump P′ thus can be used to elevate the pressure of the loaded scrubbing medium upstream of the throttle element k′.

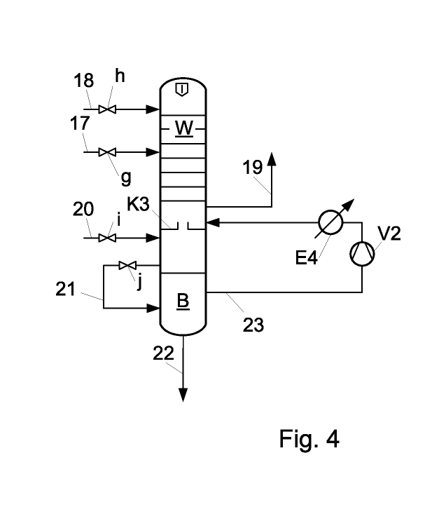

The embodiment of FIG. 4 is similar to that of FIG. 1, except for the provision of a further heat exchange between compressor V2 and scrubbing column W. Heat exchanger E4, using for example cooling water, cools the compressed gas from compressor V2, before introduction thereof into the scrubbing column W.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German application No. 10 2011 108 530.4, filed Jul. 26, 2011, are incorporated by reference herein.

1. A method for regenerating a scrubbing medium which is used at elevated pressure in a physical gas scrubber for purifying a feed gas containing hydrogen and carbon monoxide, wherein the scrubbing is loaded with carbon dioxide and sulphur components, said method comprising:
expanding scrubbing medium, loaded with carbon dioxide and sulphur components, to a pressure of 0.4-1.7 bar(a), thereby liberating carbon dioxide-rich, sulphur component-containing gas, and
compressing said carbon dioxide-rich, sulphur component-containing gas liberated during expansion, and introducing the resultant expanded gas into a first scrubbing column, wherein sulphur components are scrubbed out of the carbon dioxide-rich gas using sulphur-free scrubbing medium.

2. The method according to claim 1, wherein said scrubbing medium, loaded with carbon dioxide and sulphur components, is expanded to a pressure of 1.0-1.3 bar(a).

3. The method according to claim 1, wherein expansion of the loaded scrubbing medium is carried out in more than one step, wherein at least two carbon dioxide-rich gas mixtures are generated at different pressure levels.

4. The method according to claim 1, wherein the liberated carbon dioxide-rich, sulphur component-containing gas is cooled after compression thereof.

5. The method according to claim 1, wherein the scrubbing medium used is methanol.

6. An apparatus for regenerating a scrubbing medium which is used at elevated pressure in a physical gas scrubber for purifying a feed gas containing hydrogen and carbon monoxide wherein the scrubbing medium is loaded with carbon dioxide and sulphur components, said apparatus comprises:
an expansion vessel and a scrubbing column which are connected via a compressor, wherein loaded scrubbing medium can be expanded into the expansion vessel, and gas liberated during the expansion can be compressed using the compressor and introduced into said scrubbing column.

7. The apparatus according to claim 6, further comprising a heat exchanger arranged between said compressor and said scrubbing column, via which heat exchanger compressed gas can be cooled before being introduced into said scrubbing column.

8. The apparatus according to claim 6, wherein said apparatus comprises at least two serially-arranged expansion vessels, wherein in each case two adjacent expansion vessels are connected to one another via a throttle element, in such a manner that loaded scrubbing medium can be conducted through the expansion vessels and expanded to different pressure levels.

9. The apparatus according to claim 6, wherein the number of compressor sections of the compressor is equal to or greater than the number of the expansion vessels.

10. The apparatus according to claim 9, wherein the entry side of a compressor section is connected at most to one expansion vessel.

11. The apparatus according to claim 6, wherein said scrubbing column and the expansion vessel or vessels are embodied as separate components.

12. The apparatus according to claim 6, wherein said scrubbing column and the expansion vessel or vessels are embodied as a structural unit.
